(19) United States
(12) Patent Application Publication
(10) Pub. No.: US 2015/0368041 A1
(43) Pub. Date: Dec. 24, 2015

(54) Dual Door Trash Container

(71) Applicant: Jeffrey Coffin, Lake Jackson, TX (US)

(72) Inventor: Jeffrey Coffin, Lake Jackson, TX (US)

(21) Appl. No.: 14/120,690

(22) Filed: Jun. 18, 2014

(51) Int. Cl. B65F 1/14; B65F 1/06

(52) U.S. Cl. CPC B65F 1/14; B65F 1/06

(57) ABSTRACT

The Dual Door Trash Container allows a trash bag to be removed much easier and faster along with easier cleaning. The two doors swing away from the center to the left and right to allow enough room for the bag to be removed. A plastic liner system is imbedded into the main body of the container making it a sanitary system so that any liquid is not spilled out onto the floor.

There is no federally sponsored or research or development associated with this application. There is no joint research agreement associated with this application.

### BACKGROUND OF THE INVENTION

(1) Field of the Invention

The Dual Door Trash Container is a unique design and functionality compared to other containers traditionally used today.

(2) Description of the art including information disclosed under 37 CFR 1.97 & 1.98

The art described in the drawings of the design and utility function illustrate the unique ability of the Dual Door Trash Container invention. We have not found any other patents that would pose a conflict with this invention having two doors that are a part of the container. We are not intending to patent a trash container but more so the dual door capability, the ease of use, and the ease of cleaning.

### BRIEF SUMMARY OF THE INVENTION

The Dual Door Trash Container allows a much easier cleaning process with the inner plastic liner of the container. It has the two doors in the front of the container that open to allow the trash bag to be removed much easier. The ring on top of the container holds the bag and everything in place whole being used and is removed to remove the trash bag.

### BRIEF DESCRIPTION OF THE SEVERAL VIEWS OF THE DRAWINGS

There are 8 drawings in total that describe and illustrate the design and function of the Dual Door Trash Container.

FIG. 1: is the ¾ view of the invention.

FIG. 2: is the ¾ view of the invention with the top open showing the ring holder on the top inside the invention.

FIG. 3: is the ¾ view of the invention with the two doors open and the ring separated from the container.

FIG. 4: is the exploded view of all the parts of the invention.

FIG. 5: is the view of the doors latch system closed and the top press button.

FIG. 6: is the view of the doors latch system open and the top press button.

FIG. 7: is the top view with the top open revealing the ring holder separated from the container and the notches for the trash bag.

FIG. 8: is the top view with the top open revealing the ring holder onto the container holding the trash bag and the doors tightly in place.

### DETAILED DESCRIPTION OF THE PREFERRED EMBODIMENT

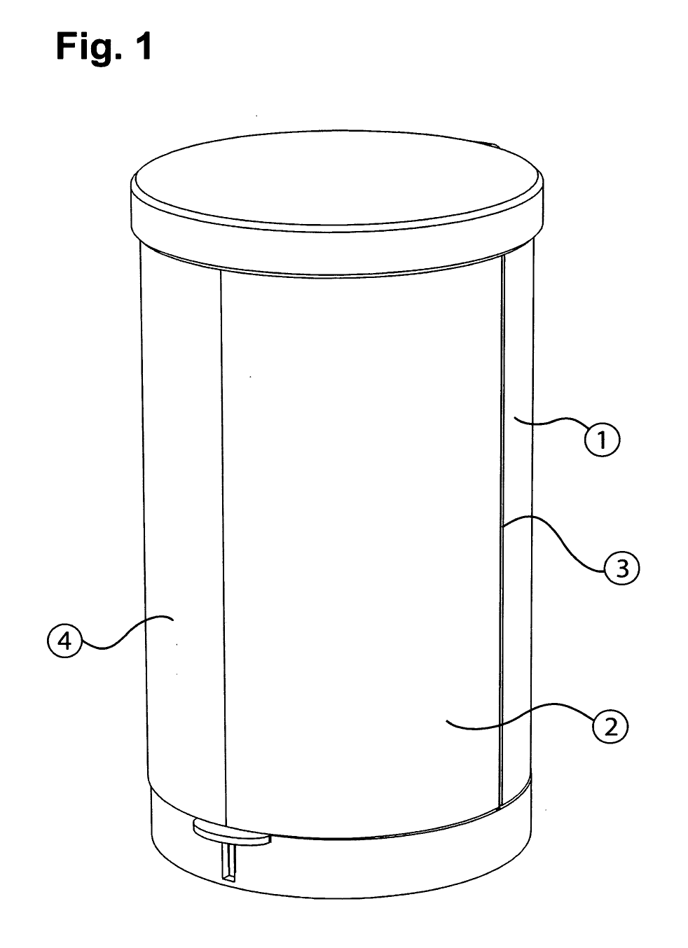

FIG. 1: In this ¾ view illustration #1 is the container main body with #2 the front view of the right door with #3 the right hinge for the door with # 4 the left door of the container.

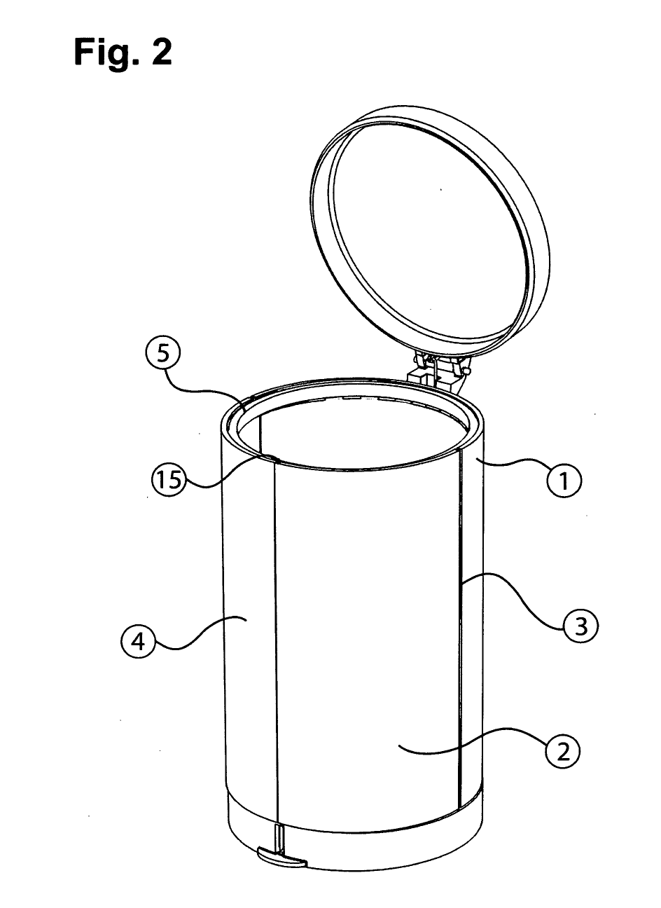

FIG. 2: In this ¾ view illustration the top lid is open with #1 is the container main body with #2 the front view of the right door with #3 the right hinge for the door with # 4 the left door of the container with #5 the detachable liner ring holder with #15 the open/close press release button.

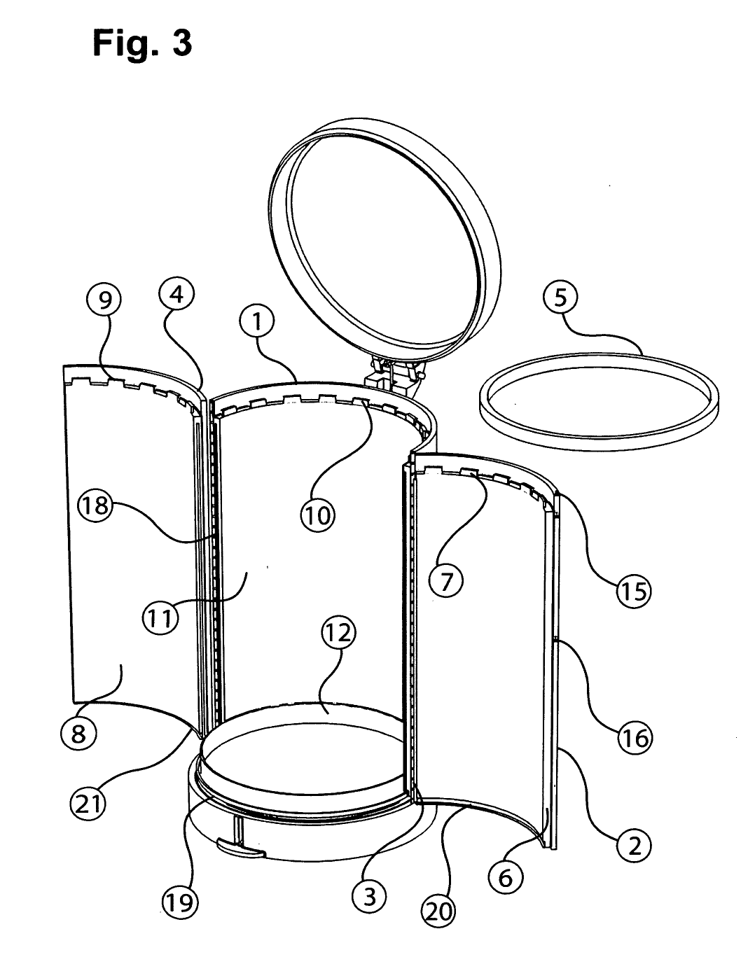

FIG. 3: In this ¾ view illustration with the top lid open and the ring is separated from the main body with #1 is the container main body with #2 the front view of the right door with #3 the right hinge for the door with # 4 the left door of the container with #5 the detachable liner ring holder with #6 the right door liner with #7 the right inner liner notches to hold the trash bag in place with #8 the left inner liner with #9 the left inner liner notches that hold the trash bag in place with #10 the back of the liner notches to hold the trash bag in place with #11 the main body liner with #12 the bottom tray liner with the raised lip with #15 the open/close press release button with #16 the right door latch hooks with #18 the left door hinge with #19 the bottom tray liner sealing ring with #20 the right door liner sealing ring for the bottom tray liner with #21 the left door liner sealing ring for the bottom tray liner.

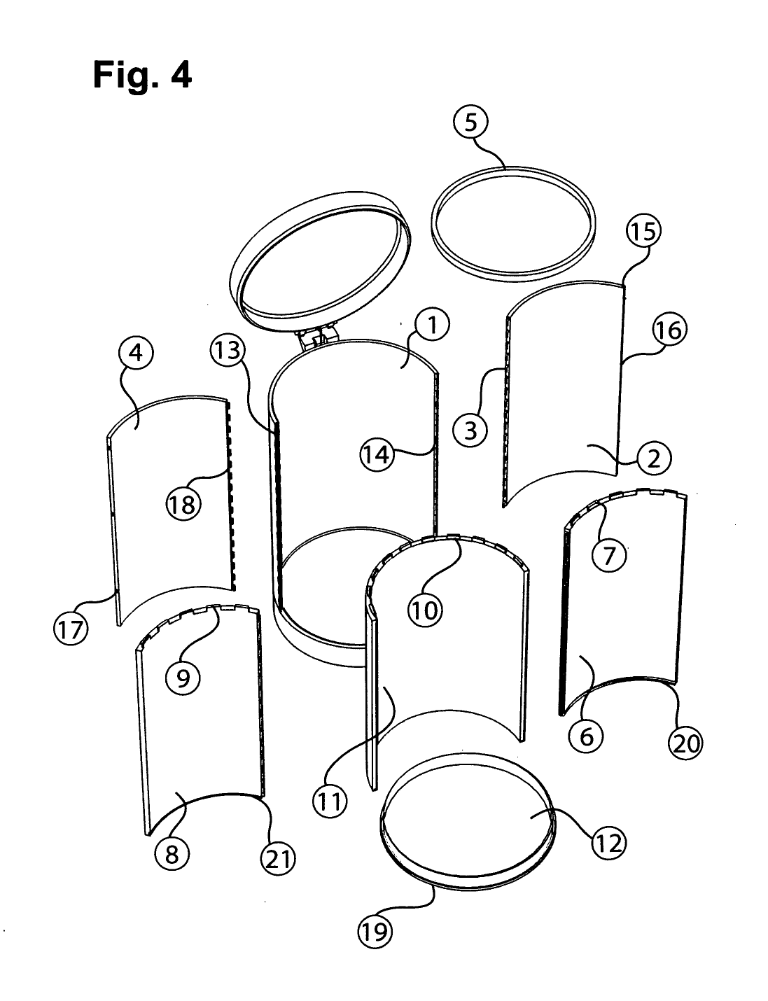

FIG. 4: In this exploded view illustration showing all of the parts with #1 is the container main body with #2 the front view of the right door with #3 the right hinge for the door with # 4 the left door of the container with #5 the detachable liner ring holder with #6 the right door liner with #7 the right inner liner notches to hold the trash bag in place with #8 the left inner liner with #9 the left inner liner notches that hold the trash bag in place with #10 the back of the liner notches to hold the trash bag in place with #11 the main body liner with #12 the bottom tray liner with the raised lip with #13 the left door hinge with #14 the right door hinge with #15 the open/close press release button with #16 the right door latch hooks with #17 the left latch pegs with #18 the left door hinge with #19 the bottom tray liner sealing ring with #20 the right door liner sealing ring for the bottom tray liner with #21 the left door liner sealing ring for the bottom tray liner.

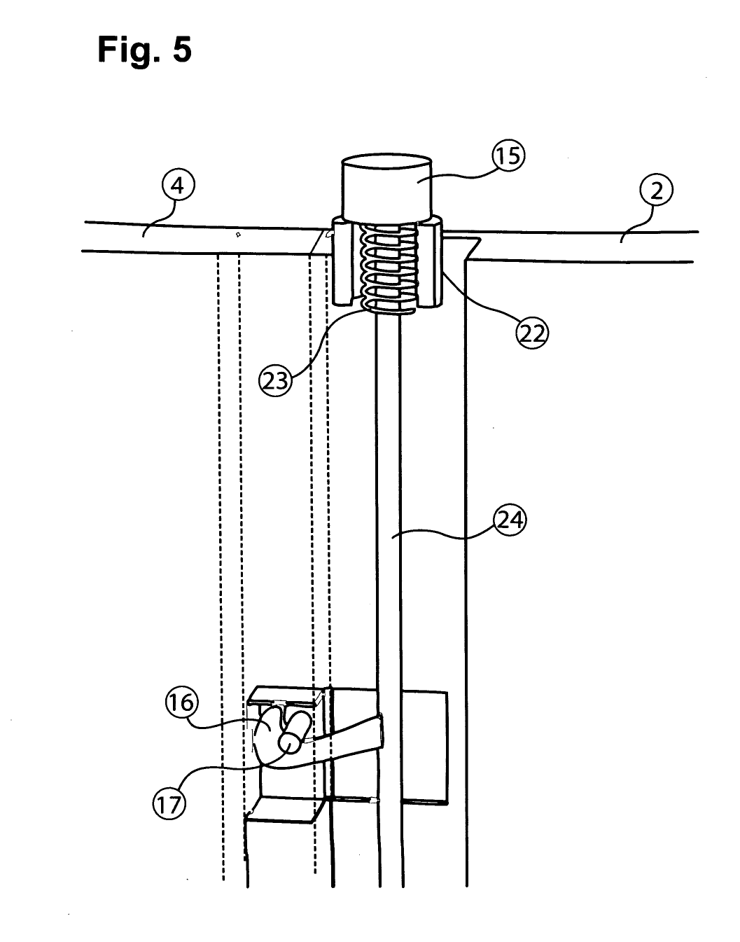

FIG. 5: In this interior view illustration shows #2 the front view of the right door with # 4 the left door of the container with #15 the open/close press release button with #16 the right door latch hook in a closed position with #17 the left latch pegs with #22 the open/close press release button base with #23 the open/close press release button spring with #24 the open/close press release button rod or piston.

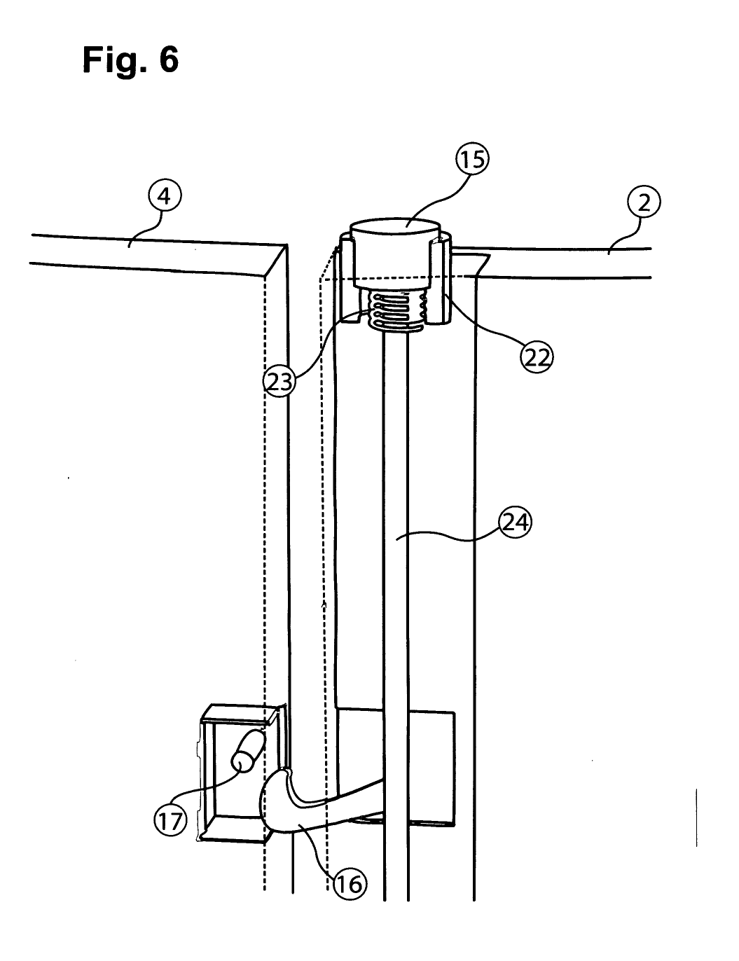

FIG. 6: In this interior view illustration shows #2 the front view of the right door with # 4 the left door of the container with #15 the open/close press release button with #16 the right door latch hook in an open position with #17 the left latch pegs with #22 the open/close press release button base with #23 the open/close press release button spring with #24 the open/close press release button rod or piston.

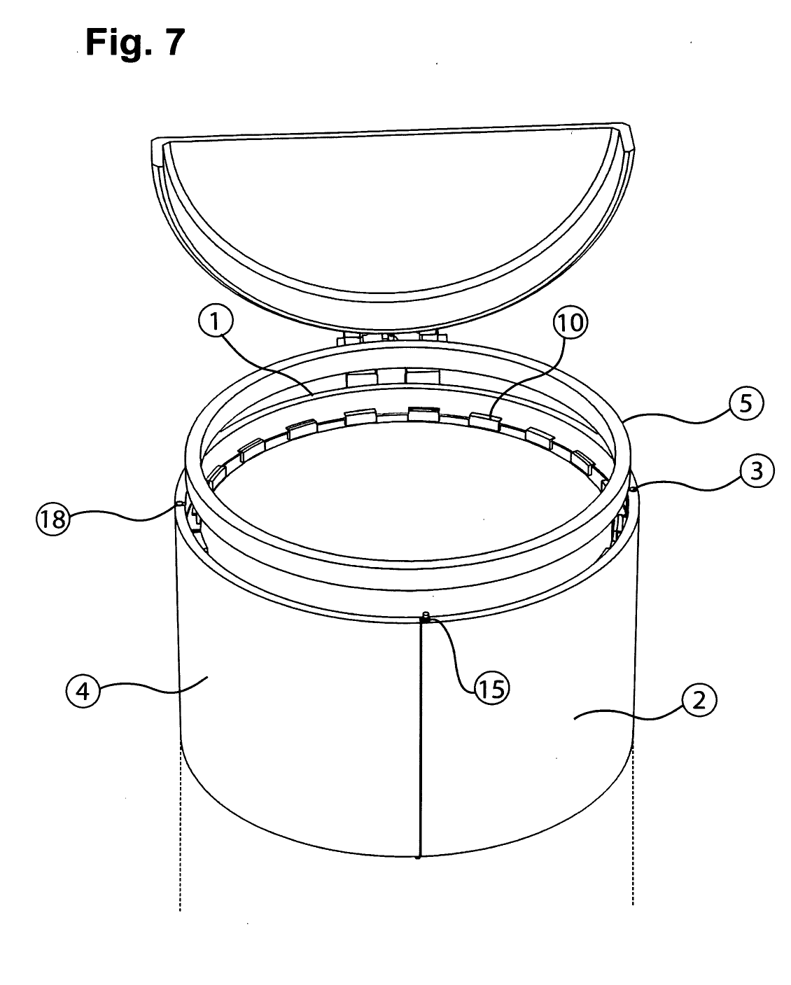

FIG. 7: In this top view lid open with the ring separated illustration shows #1 is the container main body with #2 the front view of the right door with #3 the right hinge for the door with # 4 the left door of the container with #5 the detachable liner ring holder with #10 the back of the liner notches to hold the trash bag in place with #15 the open/close press release button with #18 the left door hinge.

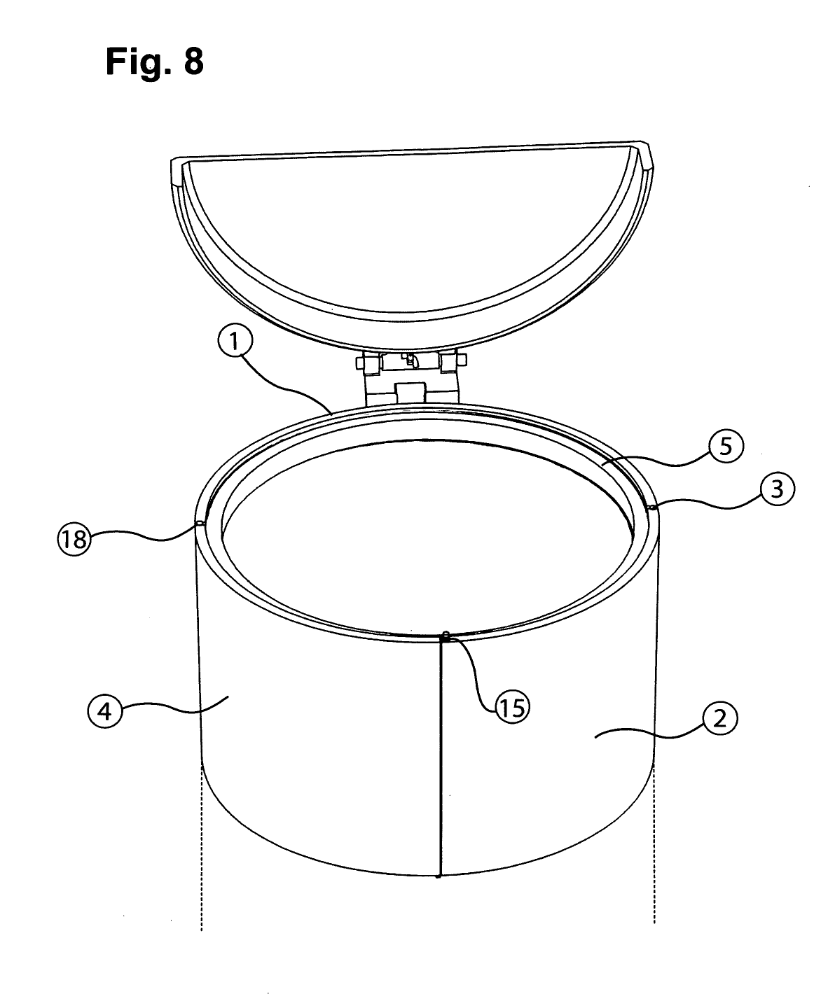

FIG. 8: In this top view lid open ring connected illustration #1 is the container main body with #2 the front view of the right door with #3 the right hinge for the door with # 4 the left door of the container with #5 the detachable liner ring holder with #15 the open/close press release button with #18 the left door hinge.

### DETAILED DESCRIPTION OF THE INVENTION

A note to the examiner . . . We are not intending to reinvent a trash container but rather to invent a dual door capability with a unique design and functionality. We did not include broken lines as the main body of the trash container as it is important to the overall patent.

The Dual Door Trash Container is a new concept in trash containers for commercial and for home use. The trash container can be in many different shapes and sizes such as round, square, rectangular, oval and any other shape conceived. The focus on this application is the dual door capability of the container. The shape chosen for this application is a round shape. In every shape there are two hinges on the right side and the left side. In a round shape the hinges on each side would be at the half way point and in the middle of the round shape diameter or circumference. In a square or rectangular shape it could be at the more front portion of the container along as it has two hinges with one on each side making the opening the full diameter of the container allowing a trash bag to be removed from the side instead of the top. This makes it much easier to remove the trash bag and to clean the plastic liner that are in most trash containers we see today. There are other patents that have a side door to remove the trash bags but most of what we have seen are commercial containers. We have designed something more for the home use. In our design the two dual doors meet in the center and swing away from each other from the center. Each door has a hinge on the left and right side of the main body of the container. On the top of the center between the two doors is a press release button to release the latch that holds the two doors together when in a closed position. When the button is pressed the latch is released and the two doors will open. The left door is closed first then the right door with the latch. When the latch is in place the doors are closed tightly and sealed. The bottom tray liner has a lip that is about two to three inches high making it hold any liquid that may fall into the tray. The doors have plastic liners that keep any liquid from touching the outer portion of the doors or the main body of the container. The door liners have an indented portion to act as a sealing mechanism to help any liquid to fall into the bottom tray liner and will stop any leaking from the trash container. The container as with any other container may have a top lid that is operated by a foot pedal at the bottom front of the container. When the top lid portion is open it has a top ring that holds the trash bag in place when the container is being used. There are notches located on the top inside portion of the main body that hold the trash bag in place. When the ring is placed onto the top portion and pressed into the notches the trash bag is held tightly in place. When the top lid is open the ring can be removed to allow the tying of the trash bag shut and then pulled out of the main body of the container from the side. This makes it so much easier to remove the bag and to clean the liner. The dual doors are a great improvement over any trash containers used today. The aspects indicated in this description and within this application are what we are intending to patent.

What is claimed is:

1. A trash container main body having two doors that open and swing away from the center portion to the left and right with parts and functionalities comprising of:
a container main body with a right door and left door each with a hinge on the right and left side of the main body that is equal to the center diameter of the main body;
a container main body detachable liner ring holder that is pressed into place holding the trash bag in place and which can be removed to remove the rash bag from the main body of the container.

2. A trash container main body with a liner system comprising of:
a right door liner with inner liner notches to hold the trash bag in place with a left door inner liner with left inner liner notches that hold the trash bag in place with the back portion of the main body of the container with liner notches on the top portion of the liner to hold the trash bag in place;
a main body liner with a bottom tray liner with the raised lip with a bottom tray liner sealing ring.

3. A trash container with two doors comprising of:
a left door hinge with a right door hinge with an open/close press release button;
a right door latch hook with the left latch peg;
a left door hinge with the bottom tray liner sealing ring with the right door liner sealing ring for the bottom tray liner with the left door liner sealing ring for the bottom tray liner;
an open/close press release button base located at the top center of the two doors with the open/close press release button spring with the open/close press release button rod or piston.
